(19) United States
(12) Patent Application Publication
(10) Pub. No.: US 2022/0254243 A1
(43) Pub. Date: Aug. 11, 2022

(54) SYSTEM FOR THE MONITORING OF THE STATUS OF FURNISHING COMPONENTS, IN PARTICULAR FOR THE INTERIOR FURNISHING OF RECREATIONAL VEHICLES OR THE LIKE

(71) Applicant: TECNOFORM S.P.A., Valsamoggia (BO) - Frazione Crespellano (IT)

(72) Inventor: Gabriele RICCI, Valsamoggia (BO) - Frazione Crespellano (IT)

(73) Assignee: TECNOFORM S.P.A., Valsamoggia (BO) - Frazione Crespellano (IT)

(21) Appl. No.: 17/622,343

(22) PCT Filed: Jun. 28, 2019
(86) PCT No.: PCT/IB2019/055520

§ 371 Date: Dec. 23, 2021

(51) Int. Cl. G08B 21/18; H04Q 9/00

(52) U.S. Cl. CPC G08B 21/18; H04Q 2209/823; H04Q 2209/47; H04Q 9/00

(57) ABSTRACT

A system (and method) for the monitoring of the status of furnishing components, in particular for the interior furnishing of recreational vehicles or the like. The system comprises one sensor device installed on at least one furnishing component, the sensor device being selected from the list comprising: humidity sensor, temperature sensor, impact sensor, location sensor; one data processing unit operatively connected to the sensor device, configured to process data coining from the sensor device and installed on the furnishing component or arranged in the proximity of the furnishing component, and one remote control unit operatively connected to the data processing unit and configured to monitor the status and/or the conditions of use of the furnishing component.

### TECHNICAL FIELD

The present invention relates to a system for the monitoring of the status of furnishing components, in particular for the interior furnishing of recreational vehicles or the like.

### BACKGROUND ART

It is specified that, in the present treatise, the term “status” means the physical and functional condition of a furnishing component, i.e., everything that concerns the physical integrity and correct functionality thereof.

Furthermore, in the present treatise, the term “furnishing component” means any piece of furniture, the functionality of which does not require a predominantly electrical/electronic part, such as sideboards, doors/hatches, drawers, worktops, sinks/bathtubs/shower trays, thus excluding proper household appliances.

In addition, “recreational vehicles or the like” means vehicles intended not only for the transport of persons but also for habitability, some examples of which are mobile homes and caravans.

At present, a number of applications are known to include sensor devices inside household appliances, including so-called domotics applications. Domotics is a type of home automation that comprises, besides household appliances, also technological tools aimed at automating and/or remote controlling household appliances.

In addition, an Internet connection allows several appliances to be interconnected and controlled remotely, according to a pattern of use traditionally called the “Internet of Things”.

Furthermore, known from the patent application number US2010/085155 A1 is the use of a liquid detection system provided with wettability sensors combined with the above appliances to make sure the latter are not wet.

However, this type of system has a number of major limitations, including the not insignificant fact that it is only limited to monitoring the presence of liquids.

Moreover, systems of known type typically use sensor devices installed only in household appliances or electrical devices in general, thus limiting their monitoring possibilities mainly to electrical and electronic components.

Furthermore, the use of sensor devices is not generally used to monitor the status of household appliances, but rather to monitor other aspects of operation, such as energy consumption, which in fact makes appliances more efficient, but does not give indications on maintenance and degradation in the short and long term.

Another drawback of these known systems provided with sensor devices is the fact that, in the event of a breakage during the warranty period of a household appliance, it is difficult to determine whether the manufacturing company should take charge of the damage in its entirety, because it is not possible to trace the way in which the damaged appliance is used, except indirectly and with the consequent risk of disputes arising. In addition, sensor devices such as those currently implemented in household appliances can detect malfunctions and damage and launch alarms accordingly, but with the sole purpose of limiting the damage in question, without taking into account the durability of the appliance itself or the possibility of implementing activities to prevent malfunctions before they occur.

Finally, these known systems are mostly used in household applications, while the market for recreational vehicles such as caravans and motorhomes does not yet benefit from these technologies, except for the on-board appliances only.

Another known technology, in the context of the implementation of electronic devices in furnishing components, concerns the use of identification and monitoring systems to identify and monitor the status of goods when these are shipped and before they arrive at their destination. Systems of this type comprise, for example, barcodes, 2D and RFID codes to identify products, but also remote monitoring systems that are able to provide information on the physical status of goods while they are traveling.

It is specified that, in the present treatise, “2D code” means any code in which the information is contained on several levels according to a two-dimensional arrangement, such as e.g. a QR code, but also any code consisting of two overlapping barcodes would be qualified as a 2D code. The systems described above, however, have some limitations, including the fact that they are used not for monitoring the status of the goods during their active life, but only during the shipping phase.

The main aim of the present invention is to devise a system for the monitoring of the status of furnishing components, in particular for the interior furnishing of recreational vehicles or the like, which allows monitoring the status of the furnishing components during their active life, to detect without uncertainty the ways in which any degradation and damage are generated and to establish accordingly whether to validate or reject the guarantee.

Another object of the present invention is to devise a system capable of interacting with the users of the furnishing components, signaling any incorrect and/or potentially hazardous uses for the structural and functional integrity, through a widely available device such as e.g. a mobile phone or a tablet.

Moreover, another object of the present invention is to devise a system for the monitoring of the status of even non-electrical/electronic furnishing components.

Another object of the present invention is to provide a system for the monitoring of the status of furnishing components, in particular for the interior furnishing of recreational vehicles or the like, which allows overcoming the aforementioned drawbacks of the prior art in the context of a simple, rational, easy, effective to use and low cost solution.

The aforementioned objects are achieved by the present system for the monitoring of the status of furnishing components, in particular for the interior furnishing of recreational vehicles or the like, having the characteristics of claim 1.

The aforementioned objects are also achieved by the furnishing component, in particular for the interior furnishings of recreational vehicles or the like, having the characteristics of claim 14.

### BRIEF DESCRIPTION OF THE DRAWINGS

Other characteristics and the advantages of the present invention will emerge from the description of a preferred, but not exclusive, embodiment of a system for the monitoring of the status of furnishing components, in particular for the interior furnishing of recreational vehicles or the like, given by way of an indicative yet non-limiting example, in the attached illustrations, wherein:

FIG. 1 is a schematic view of the system according to the invention;

FIG. 2 is a representation in the form of a block diagram of the system according to the invention.

### EMBODIMENTS OF THE INVENTION

With particular reference to these illustrations, reference numeral 1 globally indicates a system for the monitoring of the status of furnishing components, in particular for the interior furnishing of recreational vehicles or the like.

The system 1 for the monitoring of the status of furnishing components 2, in particular for the interior furnishing of recreational vehicles or the like, comprises at least one sensor device 3 installed on at least one furnishing component 2.

Preferably, the sensor device 3 is selected from the list comprising, but is not limited to: humidity sensor, temperature sensor, impact sensor, location sensor.

The system 1 further comprises at least one data processing unit 4 operatively connected to the sensor device 3, which is configured to process data coining from the sensor device 3 itself and is installed on at least one furnishing component 2, or is arranged in the proximity of at least one furnishing component 2.

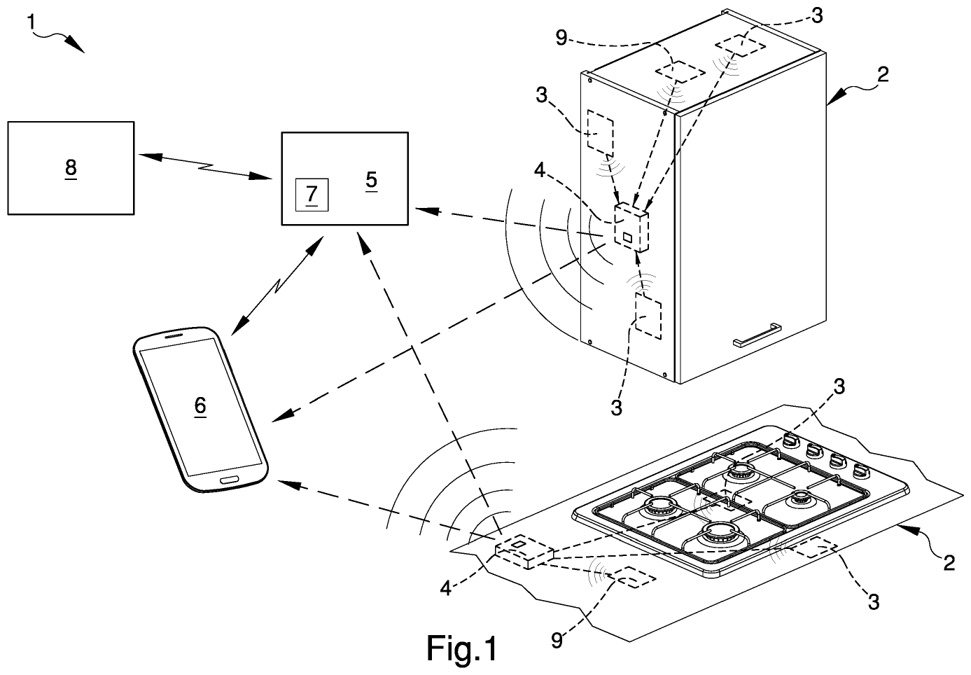

It should be noticed that, in the present treatise, the term “operatively connected” means that an object can exchange data, information or signals with another object: this connection, in the example of application in FIG. 1, is based on the use of electromagnetic waves and is wireless, but the possibility cannot be ruled out of using physical means of connection such as, e.g., power cables.

The system 1 also comprises at least one remote control unit 5, operatively connected to the data processing unit 4 and configured to monitor the status and/or the conditions of use of at least one furnishing component 2.

Advantageously, the system 1 comprises a further sensor device 3 selected from the list comprising but not limited to: air quality sensor, wetting sensor, impact sensor, location sensor.

Conveniently, the system 1 comprises in actual facts a plurality of sensor devices 3, which are installed on a plurality of furnishing components 2. Furthermore, an embodiment can be made wherein the system 1 comprises a single data processing unit 4 arranged in the proximity of the furnishing components 2 and operatively connected to the sensor devices 3.

An alternative solution is an embodiment, shown in FIG. 1, wherein the system 1 comprises a plurality of data processing units 4, which are installed on the different furnishing components 2 and are operatively connected to the sensor devices 3.

A further embodiment provides for the system 1 comprising a single data processing unit 4 installed on only one of the furnishing components 2 and operatively connected to the different sensor devices 3.

In the particular embodiment shown in FIG. 1, a data processing unit 4 is present in each furnishing component 2, which communicates with all the sensor devices 3 on the corresponding furnishing component 2, but not with the sensor devices 3 of the other furnishing components 2.

The possibility of making different alternative embodiments, such as, e.g., those set forth above, or further alternative solutions wherein, for example, several data processing units 4 are installed on the furnishing components 2 while others are arranged in the proximity, cannot be ruled out.

Advantageously, the system 1 comprises at least one user interface device 6, which is configured to communicate with at least one of the data processing unit 4 and the remote control unit 5.

In the specific case of FIG. 1, the user interface device 6 is a mobile phone, however the possibility cannot be ruled out of using different devices adapted to communicate with the data processing unit 4 and/or with the remote control unit 5, such as e.g., tablets or electronic devices built in the vehicle.

Conveniently, the data processing unit 4 is configured to receive the data from the sensor devices 3 and to send them to at least one of the remote control unit 5 and the user interface device 6.

Furthermore, the remote control unit 5 comprises processing means 7 for processing communications and/or information starting from the received data.

In particular, this information and these communications are selected from the list comprising: alarms, status notifications, marketing/services information.

Conveniently, the processing means 7 are configured to process communications and/or information starting with data coining from different sensor devices 3.

In particular, the processing means 7 are configured to process predefined communications and/or information starting with data coining from predefined sensor devices 3.

For example, the processing means 7 signal the presence of a fire if a sensor device 3 of the type of a temperature sensor signals an increase in temperature and at the same time a sensor device 3 of the type of an air quality sensor signals the presence of smoke.

What is more, the processing means 7 are configured to process predefined communications and/or information starting from the value of the data they receive.

For example, the processing means 7 signal a recreational vehicle accident if the intensity of the impact detected by a sensor device 3 of the type of a shock sensor is greater than a predefined threshold.

The system 1 also comprises a database 8, operatively connected to the remote control unit 5, adapted to store the received data, the aforementioned communications and information.

Advantageously, the system 1 comprises identification means 9 installed on each furnishing component 2, which are also readable by means of the user interface device 6.

More particularly, the identification means 9 involved are selected from the list comprising: RFID, NFC, barcode, 2D code.

The operation of the invention, according to the specific example shown in FIG. 1, is described below.

The sensor devices 3 installed on the furnishing components 2 detect data on the status and/or conditions of use of the furnishing component 2 itself.

These data are of various types, depending on the type of sensor device 3 which has detected them (humidity sensor, hours of use counter . . . ).

The detected data are sent by the sensor devices 3 to the data processing unit 4 installed on the same furnishing component 2, which processes them and sends them to the remote control unit 5, or to the user interface device 6, or to both.

The remote control unit 5, through its processing means 7, processes the incoming data and produces communications and/or information, which are sent to the user interface device 6 and to the database 8.

The information and communications produced by the remote control unit 5 concern the use of the furnishing components 2 and therefore depend on how the latter are used.

The remote control unit 5, e.g., could send an alarm to the user interface device 6 if the wetting sensors of a piece of wooden furniture detect the presence of water on the surface of the piece of furniture itself, so as to warn that it is necessary to dry it to avoid the risk of deformation of the wood or, more generally, of deterioration.

In other cases, the warnings could be the result of a combination of data coining from several sensors: it would make little sense, albeit possible, to send an alarm if the temperature sensor placed in the proximity of a stove detects a sudden rise in temperature, because this could be due to the simple ignition of the stove itself for cooking.

However, in addition to this localized increase in temperature, a humidity sensor of another piece of furniture could detect an excessive increase in humidity: from the sum of the two temperature and humidity data, therefore, it can be deduced that the vehicle has not been ventilated and an alarm can be sent to the user interface device 6, to warn that it is advisable to open the windows in order to bring the humidity/temperature conditions back within the furnishing safety (and warranty) parameters.

Other information and communications may be status notifications, concerning one or more furnishing components 2, which differ from the alarms described above inasmuch as they relate to the general condition of the furnishing components 2 to which they refer, and do not simply indicate a critical condition which is occurring at any one time.

Finally, the remote control unit 5 can process targeted marketing/service information based on the customer's use of the furnishing components 2. The function of the database 8 is to store the data, information and communications described thus far.

The recurrence of certain risk conditions, such as the detection of repeated and intense impacts on a same furnishing component 2, can therefore be stored and used to determine whether any specific damage is covered by the warranty or whether it should be to the charge of the customer.

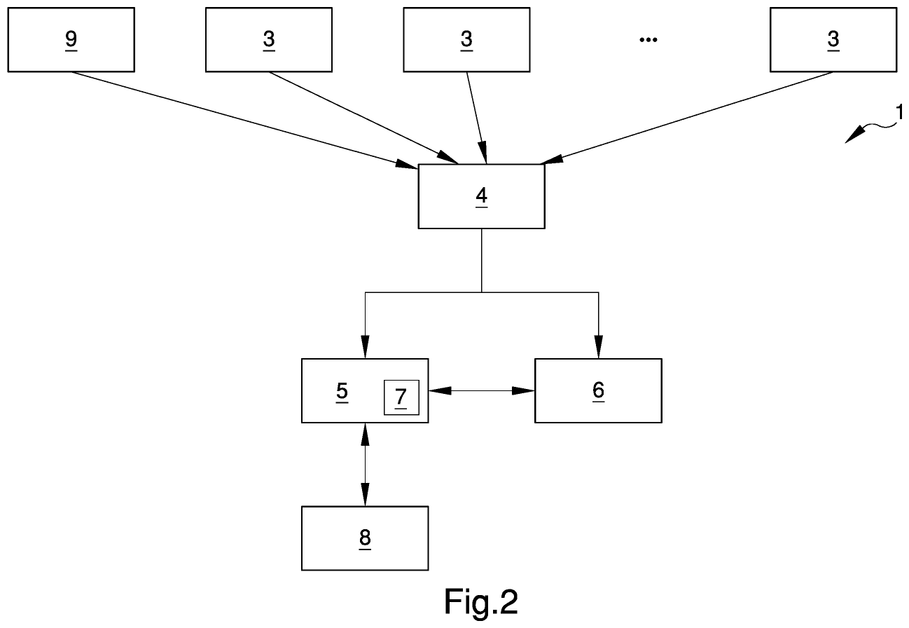

FIG. 2 summarizes in a block diagram the description of system 1, explicitly showing the network of operational connections (shown by arrows) and considering the presence of a plurality of sensor devices 3.

It has in practice been ascertained that the described invention achieves the intended objects.

In particular, the fact is underlined that this system permits monitoring the status of furnishing components during their active life and detects in a reliable way the ways in which any degradation and damage are generated, thus deciding whether to validate or reject the warranty.

Furthermore, this system is able to interact with the users of the furnishing components, indicating any misuse and/or use potentially risky for the structural and functional integrity, by means of a widely available device such as a mobile phone or a tablet.

In addition, this system is able to monitor the status of non-electrical/electronic furnishing components.

1) A system for the monitoring of the status of furnishing components, the system comprising:
at least one sensor device installed on at least one furnishing component, said sensor device being selected from a list comprising: humidity sensor, temperature sensor, impact sensor, location sensor;
at least one data processing unit operatively connected to said at least one sensor device, configured to process data coming from said at least one sensor device and installed on said at least one furnishing component or arranged in the proximity of said at least one furnishing component; and
at least one remote control unit operatively connected to said data processing unit and configured to monitor the status and/or the conditions of use of said at least one furnishing component.

2) The system according to claim 1, wherein
said at least one further sensor device is selected from the list comprising: air quality sensor, wetting sensor, impact sensor, location sensor.

3) The system according to claim 1, further comprising:
a plurality of sensor devices installed on a plurality of furnishing components.

4) The system according to claim 1, further comprising:
a single data processing unit arranged in the proximity of said furnishing components and operatively connected to said sensor devices.

5) The system according to claim 1, further comprising:
a plurality of data processing units installed on said furnishing components and operatively connected to said sensor devices.

6) The system according to claim 1, further comprising:
a single data processing unit installed on one of said furnishing components and operatively connected to said sensor devices.

7) The system according to claim 1, further comprising:
at least one user interface device, configured to communicate with at least one of said data processing unit and said remote control unit.

8) The system according to claim 1, wherein
said data processing unit is configured to receive said data from said sensor devices and to send them to at least one of said remote control unit and said user interface device.

9) The system according to claim 1, wherein
said remote control unit comprises processing means for processing communications and/or information starting from said data.

10) The system according to claim 9, further comprising:
a database operatively connected to said remote control unit, for the storage of said data, said communications and said information.

11) The system according to claim 9, wherein
said information and said communications are selected from the list comprising: alarms, status notifications, marketing/services information.

12) The system according to claim 7, wherein
said furnishing component comprises identification means which are readable by means of said user interface device.

13) The system according to claim 12, wherein
said identification means are selected from the list comprising: RFID, NFC, barcode, 2D code.

14) A furnishing component, comprising:
at least one sensor device selected from the list comprising: humidity sensor, temperature sensor, impact sensor, location sensor.

15) A furnishing component according to claim 14, further comprising:
at least one further sensor device selected from the list comprising: air quality sensor, wetting sensor, usage time counter.

16) A furnishing component according to claim 14, further comprising:
at least one data processing unit operatively connected to said at least one sensor device.

17) A furnishing component according to claim 14, wherein
said at least one sensor device is operatively connected to at least one data processing unit which is arranged in the proximity of said furnishing component.

18) A furnishing component according to claim 16, wherein
said data processing unit is configured to receive said data from said sensor devices and to send them to at least one of at least one remote control unit and at least one user interface device.
